(19) United States
(12) Patent Application Publication
(10) Pub. No.: US 2011/0045180 A1
(43) Pub. Date: Feb. 24, 2011

(54) METHOD OF MANIPULATING THE SURFACE DENSITY OF FUNCTIONAL MOLECULES ON NANOPARTICLES

(75) Inventors: I Ming HSING, Hong Kong (HK); Wenting ZHAO, Hong Kong (HK)

Correspondence Address: THE NATH LAW GROUP, 112 South West Street, Alexandria, VA, 22314, US

(73) Assignee: THE HONG KONG UNIVERSITY OF SCIENCE AND TECHNOLOGY, Hong Kong (HK)

(21) Appl. No.: 12/860,958

(22) Filed: Aug. 23, 2010

Related U.S. Application Data
(60) Provisional application No. 61/272,160, filed on Aug. 24, 2009.

(51) Int. Cl. B05D 7/00; B82Y 40/00

(52) U.S. Cl. 427/216; 427/212; 977/890

(57) ABSTRACT

Provided herein is a method for manipulating the surface density of functional molecules conjugated to nanoparticles, which method including incubating nanoparticles with nucleotides to form nucleotide-coated nanoparticles, adjusting buffer and salt concentration of the conjugation media, adding thiolated molecules in the conjugation media to incubate with the nucleotie-coated nanoparticles, and adding thiolated oligo(ethylene glycol) in the conjugation media to cease the conjugation process of thiolated molecules to nanoparticles. The method is simple, efficient and cost effective, and the surface density of functional molecules can be quickly manipulated in a wide range for various applications, such as biosensing, molecular diagnostics, nanomedicine, and nano-assembly.

### CROSS-REFERENCE TO RELATED APPLICATIONS

Pursuant to 35 U.S.C. §119(e), this application claims the benefit of U.S. Provisional Application, Ser. No. 61/272,160, filed on Aug. 24, 2009 in the name of I-Ming Hsing et al., which is entitled “ Method of manipulating the surface density of functional molecules on nanoparticles.” The provisional application is hereby incorporated by reference as if it were fully set forth herein.

### BACKGROUND OF THE INVENTION

1. Field of the Invention

The present subject matter relates to preparation of nanoparticles having functional molecules attached thereto. In particular, the present subject matter relates to a method for preparing nanoparticles conjugated with thiolated or phosphorothiolated molecules that are synthetic or natural DNA or peptides, and a use of the functionalized nanoparticles for detecting biomolecules.

2. Description of Related Art

Nanoparticles, especially noble metal nanoparticles, such as gold nanoparticles, have been well known in the art for their size-dependent physical and chemical properties. Upon being functionalized with thiol-moieties, they have been widely used in the development of molecular diagnostics, nanomedicines and nanotechnology. In particular, DNA functionalized gold nanoparticles (Au-nps) have been intensively studied as a model system, which have been successfully applied in bio-analytical applications for nucleic acids, proteins and metal ions, as well as in cell imaging, cancer treatment, and nanofabrication. The density of DNA molecules on the Au-nps surface varies, depending on the particular application, from a few strands to more than a hundred strands per one nanoparticle.

For example, in DNA hybridization based biosensing, a high surface loading of DNA on Au-nps from tens to more than a hundred DNA strands per particle results in strong inter-particle interactions and sharp transition of their characteristic melting temperature, which are critical for detection sensitivity. Mirkin et al., J. Am. Chem. Soc., 2003, 125, 1643-1654; J. Am. Chem. Soc., 2005, 127, 12754-12755. A large number of DNA strands on Au-nps can also serve as a powerful signal amplifier for the ultrasensitive detection of proteins in nanoparticle-based bio-barcode assays. Mirkin et al., Science, 2003, 301, 1884-1886. When using DNA-modified Au-nps for intracellular gene regulation, a tight packing of DNA may prevent its degradation by nucleases. Mirkin et al., Science, 2006, 312, 1027-1030. High DNA surface coverage is also necessary to stabilize Au-nps for the enzymatic manipulation of Au-nps bound DNAs, as well as to further improve the reaction efficiency. Brust et al., J. Mater. Chem., 2004, 14, 578-580; Qin and Yung, Biomacromolecules, 2006, 7, 3047-3051.

On the other hand, low DNA density is required for the rational design of

DNA based nano-assembly of Au-nps, where nanoparticles bearing one to several DNA strands each act as elementary building blocks: terminus (1 strand), lines (2 strands), corners (3 strands), vertex (4 strands), etc. Alivisatos et al., Angew. Chem., Int. Ed., 1999, 38, 1808-1812; J. Am. Chem. Soc., 2004, 126, 10832-10833; Chem. Mater., 2005, 17, 1628-1635.

Two distinct methods have been widely used in preparing the functionalized nanoparticles which meet the extreme needs of DNA density in various applications.

In order to achieve a high DNA surface density for the applications, for example, massive hybridization-based biosensing, Mirkin et al., J. Am. Chem. Soc., 120, 1959-1964 (1998); U.S. Pat. No. 6,361,944; U.S. Pat. No. 6,777,186; U.S. Pat. No. 6,878,814, developed a method to functionalize a dense layer of DNAs on Au-nps by directly incubating DNAs and nanoparticles together under delicate control of ionic strength, which is referred to as “direct conjugation method.” Mirkin et al. in Anal. Chem., 78, 8313-8318 (2006) and US Patent Application Publication No. 2010/0099858 (PCT filing date: Sep. 25, 2007), further studied the variables that influence DNA coverage on Au-nps, including salt concentration, spacer composition, nanoparticle size, and degree of sonication. Mirkin et al. disclose that maximum loading was obtained by salt aging the nanoparticles to ˜0.7M NaCl in the presence of DNA containing a poly(ethylene glycol) spacer; DNA loading was substantially increased by sonicating the nanoparticles during the surface loading process. Although largely influenced by the variables described in Mirkin et al., above, the actual DNA loading is generally manipulated by the incubation ratio of DNA and Au-nps. Also, Mirkin et al. did not study controlling the density of DNA loading on Au-nps to prepare either high DNA loading or low DNA loading within a short time depending on the applications intended. Brust, et al., Angew. Chem., Int. Ed., 42, 191-194 (2003), further improved the DNA surface loading by applying vacuum centrifugation in the direct conjugation process.

However, a DNA layer formed in the direct conjugation method needs to be dense enough to stabilize nanoparticles. Low loading of target DNA is not favorable, unless diluent strands are incorporated together with targets to maintain the overall density. Moreover, long incubation (20 hours to 2 days) is inevitable for this conjugation process due to the electrostatic repulsion between DNA molecules and particle surfaces.

Meanwhile, one of the common methods to produce low DNA loading on Au-nps was reported by Alivisatos et al. Alivisatos et al., Nature, 382, 609-611 (1996), produced conjugates with single or a few DNA attachments using a coating layer of bis(p-sulfonatophenyl)phenylphosphine dihydrate (BSPP), which is referred to as “BSPP coating method.” The whole conjugation time is shortened to ˜12 hours and the number of DNA attached per particle is statistically distributed. However, the DNA density is difficult to increase due to the hindrance of the BSPP layer.

As such, it is noted that the control of DNA density in neither of the two methods is rapid and effective enough to cover both high and low surface loading ranges. Accordingly, a new approach to produce either low (single strand per particle) or high (tens of strands per particle) loading of functionalized molecules within a short time is needed.

### SUMMARY OF THE INVENTION

Provided herein is a method for preparing nanoparticles conjugated with functional molecules, where the density of functional molecules are manipulated by controlling the salt concentration and the time for introduction of a stopping agent. Nucleotides and stopping agents are used in the method to facilitate the process, and thereby provide facile manipulation of the surface density of the functional molecules having thiol-moieties in a wider range. The method shortens the overall process time for conjugation from days down to a few hours or minutes.

The method comprises admixing nanoparticles, nucleotides, and functional molecules under suitable conditions to form a conjugate between the nanoparticles and the functional molecules, wherein the suitable conditions comprise using a buffer, salt, and a stopping agent to cease the conjugation process, and manipulating the density of functional molecules by controlling the salt concentration and the time for introduction of the stopping agent. In one embodiment of the present subject matter, the functional molecules are thiolated molecules and the stopping agent is thiolatedoligo(ethylene glycol). Accordingly, in one embodiment, the method comprises incubating nanoparticles with nucleotides to form nucleotide-coated nanoparticles, adjusting the buffer and salt concentration of the conjugation media, adding thiolated molecules in the conjugation media to incubate with nucleotide-coated nanoparticles, and adding thiolated oligo(ethylene glycol) in the conjugation media to cease the conjugation process of thiolated molecules to nanoparticles.

The method of the present subject matter is simple, efficient and cost effective, and the surface density of functional molecules can be quickly manipulated in a wide range to meet the needs of various applications, including biosensing, molecular diagnostics, nanomedicine, and nano-assembly.

### BRIEF DESCRIPTION OF THE DRAWINGS

FIG. 1 shows a schematic illustration of the present subject matter. FIG. 1(a) shows a scheme for controlling two factors in the manipulation of the density of functional molecules on Au-nps. FIG. 1(b) shows a scheme according to one embodiment of the present subject mater.

FIG. 2 shows the effect of salt concentration on the surface density of thiolated DNA molecules on Au-nps. FIG. 2(a) displays gel electrophoresis of thiolated T30/Au-nps conjugates formed in a series of NaCl concentrations of 0 mM, 10 mM, 50 mM and 100 mM of NaCl. FIG. 2(b) displays a graph showing the fluorescently measured DNA surface density of thiolated T30/Au-nps conjugates formed in the same series of NaCl concentrations in FIG. 2(a). [16] FIG. 3 shows a comparison of thiolated T5 and thiolated oligo(ethylene glycol) as stopping reagents that can be used in the present subject matter. FIG. 3(a) shows gel electrophoresis of thiolated T30/Au-nps conjugates with thiolated T5 as a stopper agent. FIG. 3(b) shows gel electrophoresis of thiolated T30/Au-nps conjugates with thiolated oligo(ethylene glycol) as a stopper agent. FIG. 3(c) shows the thiolated DNA density measured by fluorescent assays.

FIG. 4 shows an embodiment of the present subject matter where 103 bp thiolated double-stranded DNA molecules were used. FIG. 4(a) shows conjugates formed in a series of salt concentrations with thiolated oligo(ethylene glycol) introduced at 30 minutes. FIG. 4(b) shows conjugates formed in 50 mM NaCl with thiolated oligo(ethylene glycol) introduced at different time points.

FIG. 5 shows nano-assembly of Au-nps according to one embodiment of the present subject matter. FIG. 5(a) shows a scheme for the structures assembled by Au-nps through DNA hybridization. FIGS. 5(b) and 5(c) are gel electrophoresis images of the structures assembled by conjugates synthesized in the concentration of 0 mM and 50 mM NaCl respectively, with thiolated oligo(ethylene glycol) introduced at different time points. FIGS. 5(d) and 5(e) illustrate Transmission Electron Microscopy (TEM) images of dimers (second bottom band in gel) and trimers (third bottom band in gel), respectively (Scale bar: 100 nm).

FIG. 6 shows gel electrophoresis of DNA/DNA or DNA/peptide co-conjugated Au-nps with different surface densities prepared according to the method of the present subject matter. FIG. 6(a) shows two DNA/DNA co-conjugates and FIG. 6(b) shows two DNA/peptide co-conjugates.

FIG. 7 shows identification of multiple enzymes using DNA/peptide co-functionalized Au-nps conjugates. FIG. 7(a) shows gel electrophoresis of the samples before binding with streptavidin-coated magnetic particles, while FIG. 7(b) shows those after binding with streptavidin-coated magnetic particles.

FIG. 8 shows comparison of ATP-mediated approach according to the present subject matter with BSPP coating approach of prior art by gel electrophoresis in different times.

### DETAILED DESCRIPTION OF THE INVENTION

Nanoparticles useful in the embodiments of the present subject matter include, but are not limited only to, metal (non-limiting examples include gold, silver, copper and platinum), semiconductor (non-limiting examples include quantum dots, CdSe, CdS and CdS or CdSe coated with ZnS) and magnetic colloidal materials. In one embodiment, the nanoparticles are made of gold, silver or quantum dots. The size of the nanoparticles may be from 5 nm to 250, alternatively from 5 nm to 50 nm, and also alternatively from 10 nm to 30 nm, in average diameter, which can vary depending on the purpose and applications of the nanoparticles to be functionalized. Suitable nanoparticles can be prepared according to the methods well known in the art, or can be commercially available from, e.g., Ted Pella, Inc. (gold), Amersham Corp. (gold) and Nanoprobes, Inc. (gold). The nanoparticles can be modified so as to be capable of binding with functional molecules having thiol groups or thiolated moieties. Functionalized nanoparticles can be homofunctionalized nanoparticles that incorporate single biomolecule functionality or multi- or hetero-functionalized nanoparticles that incorporate two or more biomolecule functionalities.

Functional molecules that can be used in the embodiments of the present subject matter can be natural or synthetic compounds, optionally modified in the structure by a functional group or moiety, e.g., thiol group, phosphorothiolate or thiolated moiety. Such thiolated molecules may include, but are not limited only to, thiolated nucleic acids, cystein-containing peptides and phosphorothiolated molecules. Examples of such nucleic acids include, but are not limited only to, genes, viral RNA and DNA, bacterial DNA, fungal DNA, cDNA, mRNA, RNA and DNA fragments, oligonucleotides, synthetic oligonucleotides, modified oligonucleotides, single-stranded and double-stranded nucleic acids, natural and synthetic nucleic acids, etc. In one embodiment, the functional molecule is thiolated DNA.

The thiolated molecules may be a single component or a mixture of two or more components to form co-functionalized nanoparticles. Non-limiting examples of the co-functionalized nanoparticles include DNA/DNA co-functinoalized nanoparticles, DNA/peptide co-functinoalized nanoparticles, DNA/antibody co-functinoalized nanoparticles, and polyethylene glycol/peptide co-functinoalized Au-nps. In one embodiment, the DNA/DNA co-functinoalized nanoparticles are thiol-T5/thiol-T30 Au-nps or thiol-T5/biotin-thiol-DNA. In another embodiment, the DNA/peptide co-functinoalized nanoparticles are thiol-T5/Peptide 1, thiol-T30/Peptide 1, or thiol-T30/Peptide 2.

Stopping agents that can be used in the embodiments of the present subject matter include, but are not limited to, thiolated oligo(ethylene glycol) (trimer to heptamer). The stopping agents favorably compete with target functional molecules for the surface of nanoparticles, and thus can cease the conjugation process of the functional molecules with nanoparticles. However, the stopping agent has no significant replacement effect on the functional molecules conjugated onto the nanoparticles. The gel electrophoresis for thiol-T30/Au-nps conjugates incubated with thiol-oligo(ethylene glycol) for a series of time from 10 to 60 minutes can validate this as the mobility of the conjugates does not increase over the incubation with thiol-oligo(ethylene glycol).

Nucleotides that can be used in the embodiments of the present subject matter include, but are not limited only to, mononucleotide and oligonucleotide that can be bound to the surface of nanoparticles and form a nucleotide coated-nanoparticle. The nucleotides act as a coating to protect the nanoparticles from salt-induced irreversible aggregation, so that salt can be introduced to the media to minimize the charge repulsion between the nanoparticles and functional molecules to be attached thereto. Nucleotides can be RNAs or DNAs. Adenosines (e.g., ATP), adenosine-rich nucleotides, or even nucleotides composed by adenosines only (e.g. oligonucleotide poly A5, 5′-AAAAA-3′) are examples used in the particular embodiments. Nucleotides can be one type of nucleotide or a mixture of two more types of nucleotides.

Additional agents can be added to the preparation of Au-nps-functional molecules conjugates according to the present subject matter as long as they show no negative effect on the loading of the functional molecules on Au-nps. Examples of such additional agents include, but are not limited to surfactants including, for example, SDS, Tween 20 and Carbowax.

A buffer that can be used in the embodiments of the present subject matter include, but are not limited only to, a phosphate buffer, Tris buffer, and the like. The purpose of adding buffer is to maintain the solution pH value so that the charges of the functional molecules can be stable. Depending on the type, the buffer may slightly affect the preparation of Au-nps-functional molecule conjugates, but they should not negatively affect the loading of functional molecules on Au-nps. Besides, all kinds of salts can be used in the embodiments of the present subject matter as long as they can affect the ionic strength, which include, but are not limited only to, NaCl, KCl, and others with strong dissociation co-efficient in aqueous solution, in order to effectively adjust the ionic strength in the solution.

The method for preparing a nanoparticle having functional molecules attached thereto comprises admixing nanoparticles, nucleotides, and functional molecules under suitable conditions to form a conjugate between the nanoparticles and the functional molecules, wherein the suitable conditions comprise using a buffer, salt, and a stopping agent to cease the conjugation process and manipulating the density of the functional molecules to be conjugated to nanoparticles by controlling the salt concentration and the time for introduction of the stopping agent. In particular, the method comprises incubating nanoparticles with nucleotides to form nucleotide-coated nanoparticles, adjusting the salt concentration in a conjugation media, adding functional molecules into the conjugation media to incubate with the nucleotide-coated nanoparticles, and adding a stopping agent in the conjugation media to cease the conjugation process of the functional molecules to the nanoparticles.

By controlling the reaction conditions, particularly the salt concentration and the time for introduction of stopping agents, as well as the employment of nucleotides, either low (single strand per particle) or high (tens of strands per particle) loading of thiol-DNA on Au-nps is obtained within a short time, such as an hour.

To prepare DNA/Au-nps conjugates with manipulating DNA surface density in a timely manner, good control of both nanoparticle dispersion (i.e. stability) and DNA attachment kinetics are required. For better stability, Au-nps are incubated with mononucleotides, such as ATP, which can adsorb onto the particle surface to stabilize Au-nps in salt solution and can also be thermally removed and substituted by thiolated DNA.

In addition to employing the mononucleotide-coating technology to improve the salt-tolerance of Au-nps, the present method employs two mediating factors, i.e., the salt concentration and the entry point of thiolated oligo(ethylene glycol), to manipulate DNA attachment to Au-nps. The salt concentration is adjusted to control the electrostatic repulsion between the DNA and Au-nps surface and thus to control the rate of DNA immobilization. On the other hand, thiolated oligo(ethylene glycol) is introduced concurrently as an effective agent, i.e., a stopping agent, to compete against DNA molecules for the surface coverage of Au-nps. Since thiolated oligo(ethylene glycol) is a small molecule with a neutral charge, it suffers less electrostatic repulsion and enjoys a favourable binding kinetics to Au-nps in comparison to DNA.

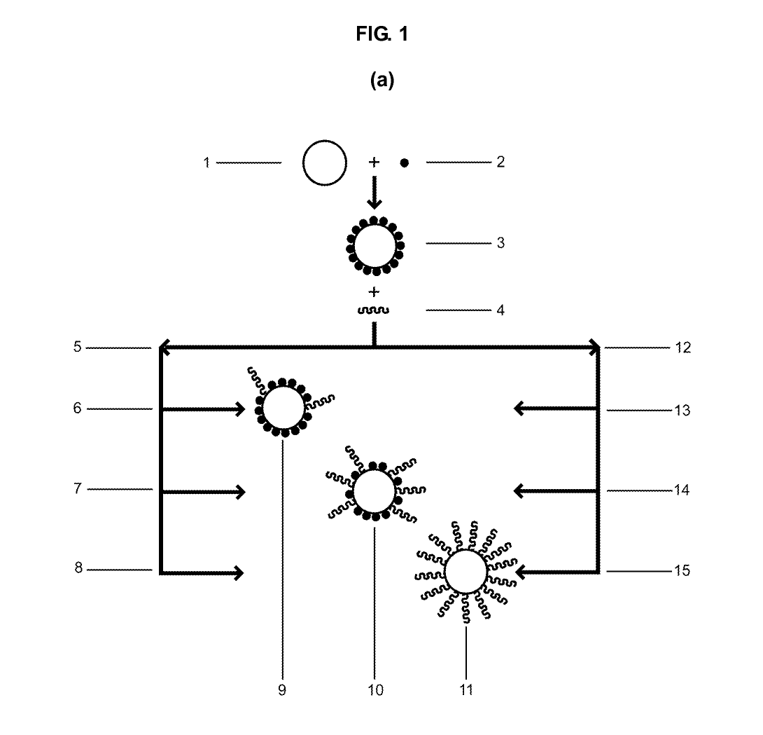

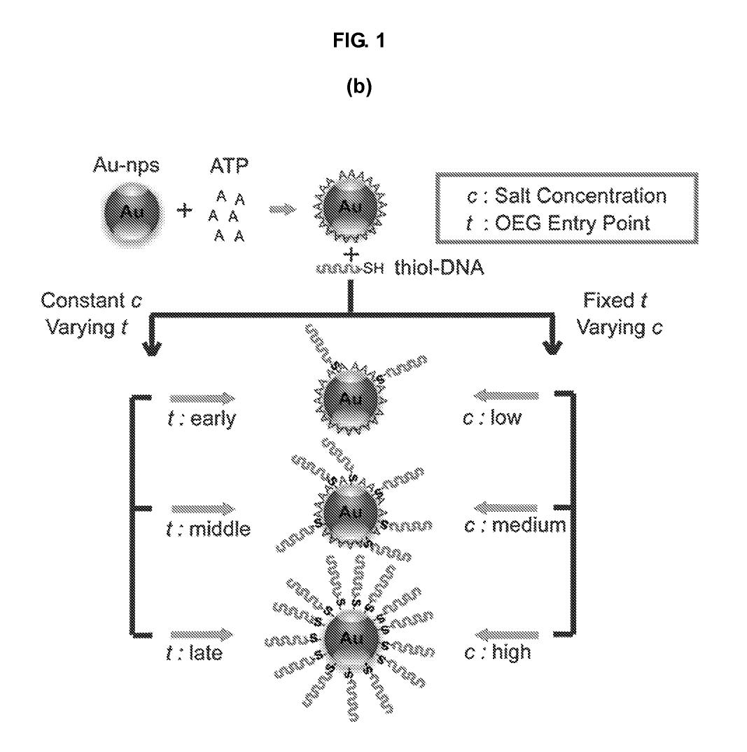

Turning now to FIG. 1(a), a schematic illustration of the present subject matter to manipulate the surface density of functional molecules on nanoparticles, nanoparticle 1 is incubated with nucleotide 2 for sufficient time, including, but not limited to, 15 minutes, to form nucleotide-coated nanoparticle 3. The formation of the nucleotide-coated nanoparticle is followed by adding buffer and adjusting the salt concentration to a certain level. Thiolated molecules 4 are then introduced in the solution, followed by incubation for certain time duration. Two factors for the manipulation of the surface density of thiolated molecules 4 on nucleotide-coated nanoparticle 3 include salt concentration 5 and the time point for the introduction of stopping agent 12. When salt concentration 5 increases from low 6 to medium 7 and to high 8, or when the time point for the introduction of stopping reagent 12 is delayed from early stage 13 to middle stage 14 and to late stage 15 of the process, the resulting conjugates have the surface density of thiolated molecules 4 on nucleotide-coated nanoparticle 3, increasing from low 9 to medium 10 and to high 11, respectively.

Further referring to the schematic illustration of FIG. 1(a), nucleotide 2 quickly stabilizes nanoparticle 1 in salt solution by forming an adsorption layer on the particle surface in a few minutes, and nucleotide 2 present on nucleotide-coated nanoparticle 3 can be further substituted by thiolated molecules 4 for the functionalization of nucleotide-coated nanoparticle 3. Zhao, et al., Langmuir, 23, 7143-7147 (2007) and Zhao, et al., Bioconjugate Chem., 20, 1218-1222 (2009).

Being protected by nucleotide 2, the salt tolerance of nucleotide-coated nanoparticle 3 is greatly improved so that the charge repulsion between nucleotide-coated nanoparticle 3 and thiolated molecules 4 can be significantly reduced as the ionic strength increases, without causing aggregation of nucleotide-coated nanoparticle 3. Since the electrostatic repulsion is the main hindrance of the conjugation, the immobilization speed of thiolated molecules 4 can therefore be tuned by adjusting salt concentration 5, resulting in conjugates with the surface density of thiolated molecules 4 varying from low 9 to medium 10 and to high 11 on nucleotide-coated nanoparticle 3 as salt concentration 5 increases from low 6 to medium 7 and to high 8, respectively.

Meanwhile, smaller and neutrally charged stopping reagent 12 binds to nucleotide-coated nanoparticle 3 much faster than thiolated molecules 4, due to its fast diffusion and less electrostatic repulsion to nucleotide-coated nanoparticle 3. In consequence, the binding of thiolated molecules 4 to nucleotide-coated nanoparticle 3 can be inhibited competitively by stopping reagent 12. The introduction of stopping reagent 12 can therefore cease the conjugation process of thiolated molecules 4 to nucleotide-coated nanoparticle 3 at different density stages to form conjugates with the surface density of thiolated molecules 4, varying from low 9 to medium 10 and to high 11 on nucleotide-coated nanoparticle 3, as the time point for the introduction of stopping reagent 12 is delayed from early stage 13 to middle stage 14 and to late stage 15 of the process.

Further referring to the schematic illustration of FIG. 1(a) and also to the schematic illustration of FIG. 1(b), adenosine triphosphate (ATP) or adenosine-rich oligonucleotide can be chosen as nucleotide 2 due to the higher affinity of adenosine to metals as compared with other types of nucleosides, as shown by Zhao, et al., Langmuir, 23, 7143-7147 (2007). Salt concentration 5 can be adjusted by adding, for example, sodium chloride (NaCl) and thiolated oligo(ethylene glycol) as stopping reagent 12, since thiolated oligo(ethylene glycol) can passivate nucleotide-coated nanoparticle 3, as well as it can prevent non-specific adsorption in many bio-assays. In one embodiment of the present method, thiolated DNA (i.e., thiolated T30: 5′-TTT TTT TTT TTT TTT TTT TTT TTT TTT TTT-C3-thiol-3′) (SEQ ID NO: 1) and 13 nm gold nanoparticles (Au-nps) are used as the functional molecule and the nanoparticles.

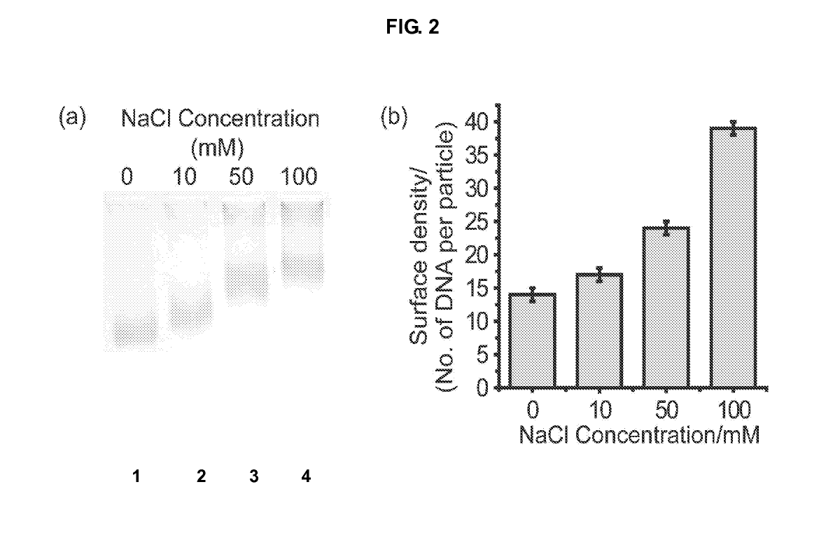

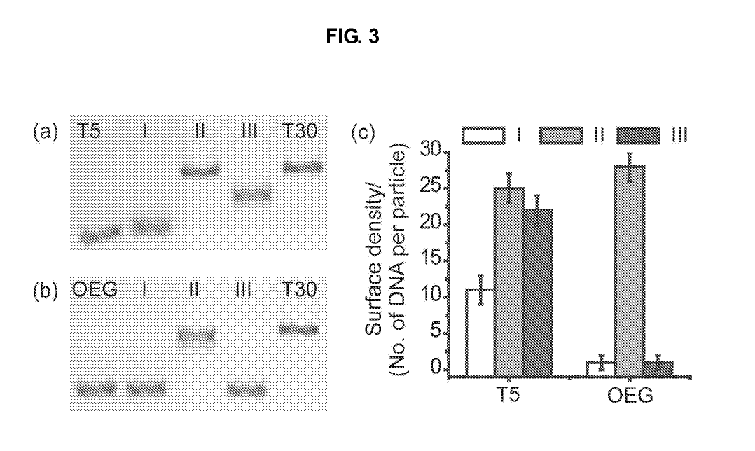

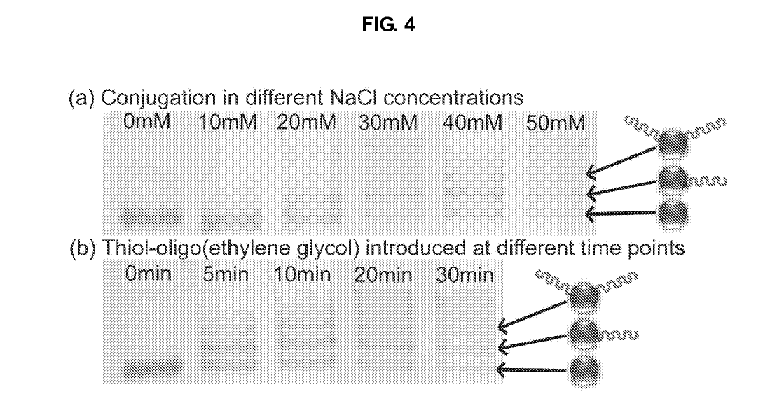

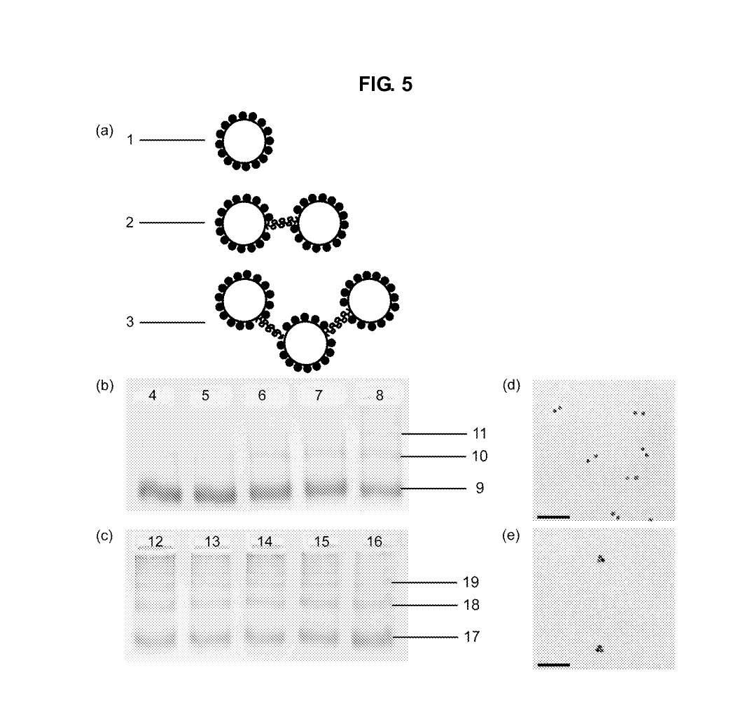

Referring to FIG. 2 showing the effect of salt concentration on the thiolated DNA surface density on Au-nps, a series of thiolated DNA/Au-nps conjugates can be synthesized in different salt concentrations of 0 mM, 10 mM, 50 mM, and 100 mM of NaCl, for 30 minutes, without introduction of thiolated oligo(ethylene glycol). The salt concentration is determined based on the charges and the surface density of functional molecules to be loaded on the nanoparticle. Generally, the charges of DNA molecules are mainly from the phosphate groups on their backbone. Therofore, the longer the DNA strands are, the higher the charges of the DNA molecules are. For longer DNAs, higher salt concentration is needed to neutralize the large charge repulsion; otherwise, lower surface density will be observed. For instance, in the conjugation of 103 bp-dsDNA (Example 1) and that of thiol-T30 (Example 2) it can seen that at the same salt concentration (0 mM NaCl), 103 bp-dsDNA is barely attached to Au-nps after 30 min (FIG. 4(a)) while thiol-T30 is successfully attached to perform DNA hybridization even at 15 min (6 of FIG. 5).

The resulting thiolated DNA density on Au-nps can first be probed by electrophoresis in 3% agarose gel, where the electrophoretic mobility of the conjugates can be retarded by the addition of thiolated DNA. Parak, et al., Nano Lett., 3, 33-36 (2003); Zanchet, et al., Nano Lett., 1, 32-35 (2001).

As shown in FIG. 2(a), the electrophoretic mobility significantly decreases as the salt concentration increases from 0 mM to 100 mM, indicating that more thiolated DNAs are loaded on Au-nps surfaces in media in higher salt concentration. DNA densities at different salt concentrations can be further quantified using a fluorescent assay as reported by Demers, et al., Anal. Chem., 72, 5535-5541 (2000) and Hurst, et al., Anal. Chem., 78, 8313-8318 (2006), where a fluorescent labeled thiolated DNA (5′-TET-T30-thiol-3′) is used instead of thiolated T30 for the conjugation. As shown in FIG. 2(b), the DNA density achieved in the salt concentration of 0 mM to 100 mM of NaCl ranges from 13 to 40 strands per nanoparticle.

Higher DNA density comparable to previous work in the art could be expected when increasing the salt concentration up to the salt-tolerance limit of Au-nps (e.g. 0.7M NaCl for ATP protected 10 nm Au-nps), or when extending the conjugation time over 3 hour incubation. Nevertheless, a wide distribution of DNA density was unavoidable in resulting conjugates as band spreading is observed in gel electrophoresis (FIG. 2(a)). This might be caused by the inaccurate “time” control of the conjugation process since the conjugation time was “stopped” by a 20-minute centrifugation step to remove excess DNA, during which the conjugation could still occur.

In order to precisely control the conjugation time, a small molecule was introduced. Examples of small molecule include thiolated oligo(ethylene glycol) and short oligo DNA thiol-T5 that can compete favorably with target thiol-DNA for the surface of Au-nps. As shown in FIG. 3, to compare the role of these two stopping agents in the conjugation, they are added to a 3 hour conjugation process in three scenarios with different time points of entry, as marked I, II and III in FIG. 3.

Referring to FIG. 3 showing the effect of stopping agents in the manipulation of the surface density of functional molecules, Scenario I shows Au-nps are incubated with thiolated oligo(ethylene glycol) or thiol-T5, and after 1.5 hour, target thiol-T30 is added to conjugate for another 1.5 hour. Scenario II shows thiol-T30 is conjugated to Au-nps at the beginning while thiolated oligo(ethylene glycol) or thiol-T5 enters at 1.5 hour. Scenario III shows that thiolated oligo(ethylene glycol) or thiol-T5 is mixed with target thiol-T30 and incubated with Au-nps for the complete 3 hour process.

The resulting conjugates are probed by gel electrophoresis, as shown in FIG. 3(a) for thiol-T5 and FIG. 3(b) for thiolated oligo(ethylene glycol), where Au-nps incubated with thiol-T30 only or a stopping agent only, either thiolated T5 or thiolated oligo(ethylene glycol), represent the conjugates with highest DNA surface loading (positive control) or lowest DNA surface loading (negative control), respectively. In scenario I and II, both thiol-T5 and thiolated oligo(ethylene glycol) exhibit a similar impact on the conjugation. Their prior approach to Au-nps prevents the conjugation of thiol-DNA, which results in much less DNA attached to Au-nps, as reflected by more retained mobility of Au-nps in scenario I than in scenario II. However, the difference between thiolated oligo(ethylene glycol) and thiol-T5 becomes obvious in scenario III, where the conjugates formed with thiolated oligo(ethylene glycol) run closely to those with lowest DNA loading while the Au-nps with thiol-T5 are retarded in-between the conjugates with lowest and highest DNA loadings. This indicates that the neutrally charged thiolated oligo(ethylene glycol) serves as a better stopping reagent than the negatively charged thiol-T5, and the conjugation of thiol-DNA to Au-nps would be significantly retarded once thiolated oligo(ethylene glycol) is introduced. The fluorescence-based DNA density measurement in FIG. 3(c) is consistent with the electrophoresis results in FIGS. 3(a) and 3(b). Clearly, thiolated oligo(ethylene glycol) is effective in controlling the conjugation time precisely.

The conjugation speed can be controlled by adjusting salt concentration, while introduction of thiolated oligo(ethylene glycol) enables a precise confinement of DNA surface density at a specific time point. Combining these factors together, the two strategies for the effective control of DNA loading, as illustrated in the scheme of FIG. 1(b), are demonstrated in the conjugation of a long DNA (i.e. thiol-103 bp) to Au-nps. Long DNA is chosen as Au-nps with different numbers of long DNA attached could be separated into discrete bands by gel electrophoresis.

The incubation time may vary for different lengths of DNA strands. Longer strands diffuse more slowly to Au-nps surfaces and longer time may need to achieve similar surface densities. For instance, in the samples (e.g., the 2^{nd} lane from left in FIGS. 4(b) and 12 of FIG. 5) prepared with a 5 minute conjugation in 50 mM NaCl, it can be seen that thiol-T30 gets higher loading on Au-nps than 103 bp-dsDNA, and thiol-T30 conjugates have multiple strands per nanoparticle to form complex nano-assemblies while 103 bp-dsDNA conjugates have mainly 1 strand attached per nanoparticle.

Using the right route of the scheme in FIG. 1(b), multiple bands with lower electrophoretic mobility begin to show up as the salt concentration increases (FIG. 4(a)). Similar results are obtained using the left route of scheme in FIG. 1(b), where the entry time point of thiolated oligo(ethylene glycol) is varied at a fixed salt concentration (FIG. 4(b)). The intensity of highest mobility band showing Au-nps with no DNA attached slowly decreased, suggesting that the DNA loading on Au-nps can be finely tuned to meet the expectations of different applications.

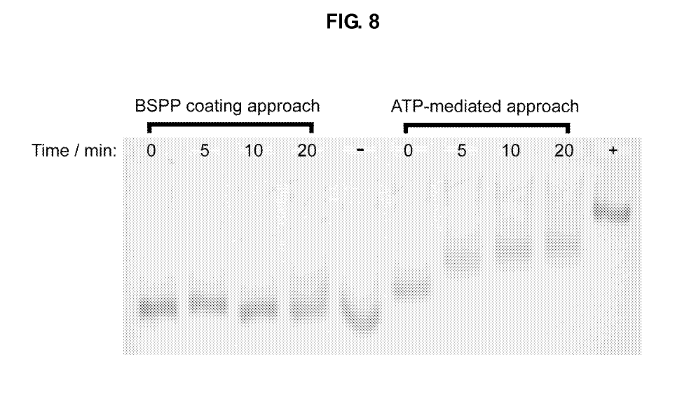

The facile and rapid control of DNA density on Au-nps can be widely applied in many applications. Taking the popular DNA-directed nano-assembly of Au-nps as an example, the synthesis of essential assembly units, i.e. stable conjugates with extremely low DNA density, can be shortened to a few minutes in the present subject matter, instead of 10 hours in the conventional BSPP coating approach since DNA links to Au-nps much faster in the present method, as shown in FIG. 8. In this regard, FIG. 8 shows a comparison of ATP-mediated approach (Lane 6 to 9) with BSPP coating approach (Lane 1 to 4) by gel electrophoresis in different times (0 minute, 5 minutes, 10 minutes, 20 minutes as shown from left to right in each approach group). The NaCl concentration in ATP-mediated approach is 50 mM. BSPP coated Au-nps without mixing with thiol-DNAs is served as negative control (marked “−”), while thiol-T30/Au-nps conjugated by ATP-mediated approach in 100 mM for 20 minutes are used as positive control (marked “+”).

In addition, as demonstrated in FIG. 5, conjugates (i.e., thiol-T30/Au-nps and thiol-A30/Au-nps) obtained after 30 minutes in 0 mM NaCl (7 of FIG. 5(b)) or as early as 5 minutes in 50 mM NaCl (12 of FIG. 5(c)) could assemble in groups through DNA hybridization and migrate into discrete bands in gel electrophoresis. Since shorter DNAs (thiol-T30 and thiol-A30) are used, the band separation in the gel is mainly attributed to the number of Au-nps assembled, which was also supported by TEM in FIGS. 5(d) and (e). Structures like dimers and trimers were synthesized successfully using low loading DNA/Au-np conjugates formed in a short time.

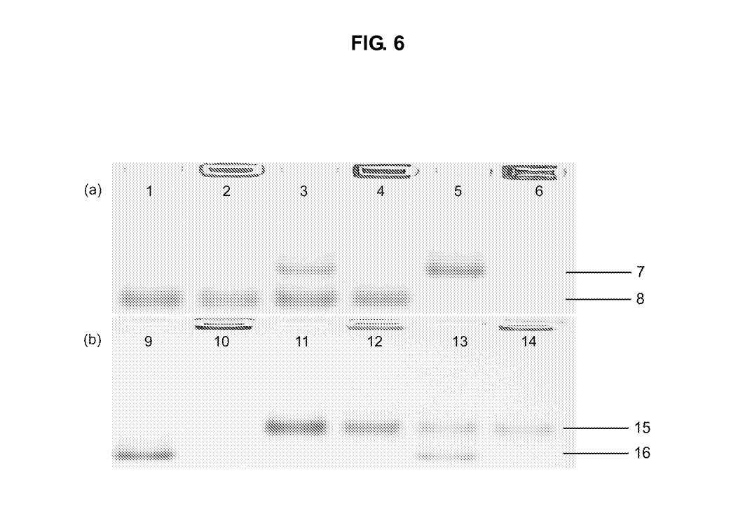

Referring to FIG. 6, co-functionalized Au-nps can be prepared according to the present method using conjugates of single or multiple components of functional molecules. They can be homofunctionalized Au-nps that incorporate one biomolecule functionality, such as DNA, peptides, or antibodies, or heterofunctionalized Au-nps including conjugates that combine oligonucleotides and antibodies, DNA-peptide, or polyethylene glycol and peptides. FIG. 6 shows gel electrophoresis of DNA/DNA or DNA/peptide co-conjugated Au-nps with different surface densities prepared according to the method of the present subject matter. FIG. 6(a) shows two DNA/DNA co-conjugates, namely Co-conjugate 1 (high density thiol-T5 and low density thiol-T30, in Lane 1 and 2) and Co-conjugate 2 (high density thiol-T30 and low density biotin-thiol-DNA, in Lane 5 and 6), and a mixture thereof (Lane 3 and 4) examined before (Lane 1, 3, 5) and after (Lane 2, 4, 6) binding with streptavidin-coated magnetic particles. FIG. 6(b) shows two DNA/peptide co-conjugates, namely Co-conjugate 3 (thiol-T5 and Peptide 1: CALNNAAGFPRGGG{biotin-Lys}) (SEQ ID NO: 2) (Lane 9 and 10) and Co-conjugate 4 (thiol-T30 and Peptide 2: CALNNAALRRASLG) (SEQ ID NO: 3) (Lane 11 and 12), and a mixture thereof (Lane 13 and 14) examined before (Lane 9, 10, 11) and after (Lane 10, 12, 14) binding with streptavidin-coated magnetic particles.

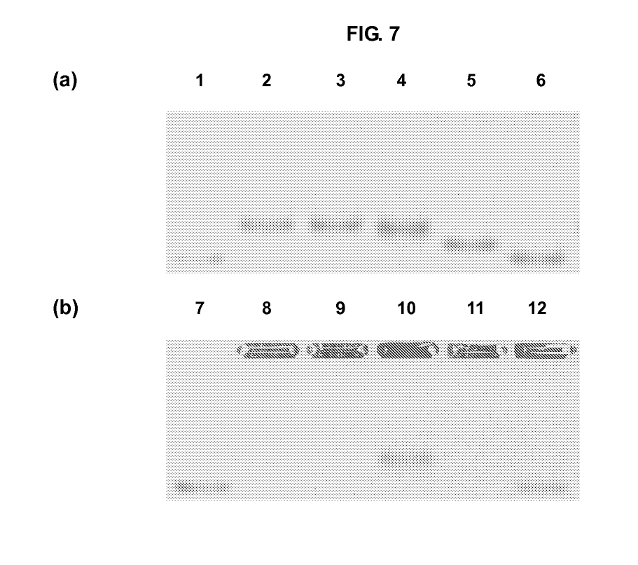

Referring to FIG. 7, the DNA/peptide co-functionalized Au-nps conjugates prepared according to the present method can be used to identify multiple biomolecules including, for example, Trypsin, DNase I, and the like. As demonstrated in FIG. 7, Trypsin, DNase I or the mixture of them can be identified through incubating with thiol-T30/Peptidel co-functionalized Co-conjugate 5 in suitable buffers to react and then mixing with streptavidin-coated magnetic particle for gel electrophoresis analysis (Details refer to Example 4). In FIG. 7, Lane 1 and 7 are Au-nps with thiolated oligo(ethylene glycol) coating only, which is used as reference, Lane 2 and 8 are Co-conjugate 5 in water that is used as reference, Lane 3 and 9 are Co-conjugate 5 mixed with Bovine Serum Albumin (BSA) in Buffer 1 (i.e., 50 mM Tris-HCl, pH 8, including 10 mM CaCl₂) as reference, Lane 4 and 10 are Co-conjugate 5 incubated with Trypsin in Buffer 1, Lane 5 and 11 are Co-conjugate 5 incubated with DNase I in Buffer 2 (i.e., 50 mM Tris-HCl, pH 7.5, including 10 mM MgCl₂ and 0.1 mM DTT), Lane 6 and 12 are Co-conjugate 5 incubated with both Trypsin and DNase I in Buffer 3 (i.e., 50 mM Tris-HCl, pH 7.5, including 10 mM MgCl₂, 10 mM CaCl₂ and 0.1 mM DTT).

In summary, the present subject matter provides a method for the facile and rapid manipulation of DNA surface density on Au-nps. With nucleotide (e.g. mononucleotide) coating on Au-nps, DNA conjugation speed can be tuned in a wide range by salt concentrations while the final DNA loading is confined by thiolated oligo(ethylene glycol) introduction. This manipulation mechanism can be readily used in applications expecting either high or low DNA loadings on Au-nps.

The advantages of the present subject matter include, without limitation, improving the stability of nanoparticles in salt solutions by nucleotide-coating, enabling the control of conjugation-speed of thiol-moieties to nanoparticles through adjusting the salt concentrations, providing a precise control of the conjugation time by introducing oligo(ethylene glycol), and resulting in conjugates with surface functionalized in a wide range of density. The present subject matter is also easy to perform without sophisticated instruments and require generally no more than a few hours to complete depending on the desired surface density.

In broad embodiment, the present subject matter is a method to manipulate the conjugation process of thiol-moieties to nanoparticles in terms of conjugation speed, processing time, conjugates stability and surface density of functional groups. It can be incorporated in any material functionalization process, any biosensing assay, or any design which can take advantages of the above terms of the present subject matter.

### Examples

The present subject matter can be illustrated in further detail by the following examples. However, it should be noted that the scope of the present subject matter is not limited to the examples. They should be considered as merely being illustrative and representative for the present subject matter.

### Example 1

### Manipulating Surface Density of 103 bp Thiolated Double-Stranded DNA Molecules Conjugated on 13 nm Gold Nanopaticles

103 bp thiolated double-stranded DNA molecules (103 bp-dsDNA) were generated by the polymeric chain reaction (PCR) of bacteriophage M13 vector with one thiolated primer (thiolated reverse primer is 5′-thiol-C6-CAG GAA ACA GCT ATG AC-3′ (SEQ ID NO: 4), and forward primer is 5′-GTA AAA CGA CGG CCA G-3′ (SEQ ID NO: 5)). The PCR product was further purified by PCRquick-spin ^{TM} PCR Product Purification Kit and the resulting concentration of purified 103 bp-dsDNA was determined by measuring the absorbance at 260 nm.

In the meantime, 1100 μL citrate-stabilized 13 nm Au-nps were incubated with ATP for 15 minutes in a molar ratio (ATP/Au-nps) of 1000. The incubated mixture was then brought to 10 mM sodium phosphate buffer (pH 8.0) for another 15 minutes, and then was divided into 11 aliquots to reach a series of NaCl concentrations in parallel, i.e., 0 mM, 10 mM, 20 mM, 30 mM, 40 mM, and 6 aliquots of 50 mM, as shown in FIG. 4. Each aliquot should contain equivalently 100 μL of 10 nM Au-nps.

Following a brief vortexing of the mixture, purified 103 bp-dsDNA was introduced in a molar ratio of 3 (103 bp-dsDNA to Au-nps). During the conjugation process, thiolated oligo(ethylene glycol) (Aldrich, Cat.#672688, O-(2-Carboxyethyl)-O′-(2-mercaptoethyl)heptaethylene glycol) was added into the mixture in a molar ratio (thiolated oligo(ethylene glycol) to Au-nps) of 1000 at different time points, i.e., 0 minute, 5 minutes, 10 minutes, 20 minutes, and 30 minutes, as shown in FIG. 4, and incubated for another 15 minutes to cease the conjugation of 103 bp-dsDNA to Au-nps. It should be noted that the ratio of thiol-DNA to Au-nps can be reduced accordingly for the low-density conjugation. The resulting mixture was washed in 10 mM sodium phosphate buffer (pH 8.0) for three times using centrifugation (13,200 rpm, 20 minutes) to remove excess reagents. Finally the as-prepared conjugates were re-suspended in gel loading buffer (1× Tris-Borate-EDTA buffer containing 5% glycerol) with 10-time concentrated for the following gel electrophoresis.

3% agarose gel was used to differentiate Au-nps with different numbers of 103 bp-dsDNA, i.e., nanoparticles without any DNA conjugated, one DNA per nanoparticle, and two DNAs per nanoparticle, as shown in FIG. 4. The electrophoresis can be run for 120 minutesin 5 V/cm electric field with 1× Tris-Borate-EDTA as the running buffer. The gel images are shown in FIG. 4, where the surface density increase are visualized by the gradual appear of discrete bands.

### Example 2

### Preparation of DNA/Au-nps Conjugates with Low Surface Density for the Nano-Assembly of Au-nps in Dimer or Trimer Structures

Two complementary thiolated DNAs (thiol-T30, 5′-TTT TTT TTT TTT TTT TTT TTT TTT TTT TTT-C3-thiol-3′ (SEQ ID NO: 1), and thiol-A30, 5′-AAA AAA AAA AAA AAA AAA AAA AAA AAA AAA-C3-thiol-3′ (SEQ ID NO: 6)) were conjugated to Au-nps, separately, using a similar approach to Example 1, except that the DNA to Au-nps molar ratio was 120 to 1 and thiolated oligo(ethylene glycol) introduced at several time points, i.e., 5 minute (4 and 12), 10 minutes (5 and 13), 15 minutes (6 and 14), and 30 minutes (7 and 15), and overnight (8 and 16, as shown in FIG. 5), in two parallel NaCl concentration groups, i.e., 0 mM as FIGS. 5(b) and 50 mM as FIG. 5(c).

As-prepared two conjugates with complementary sequences can hybridize to each other in 10 mM sodium phosphate buffer, with 0.1 M NaCl (pH 8.0) overnight to form nano-assemblies in different structures, e.g. dimers as 2 of FIG. 5 or trimers as 3 of FIG. 5. Gel electrophoresis was performed in 3% agarose gel with 1× TBE as running buffer and run for 60 minutes in electric field of 5 V/cm. As shown in FIGS. 5(b) and (c), nano-assemblies with different structures migrate to separate bands in gel, where single particle conjugates 1 runs to the front of the gel, 9 and 17, followed by dimers 2 as the second bands 10 and 18, and then trimers 3 as the third bands 11 and 19. TEM was used to visualize dimers 2 and trimers 3 as shown in FIG. 5(d) and FIG. 5(e). For TEM preparation, 0.01 % poly (L-lysine) pre-treated specimen (SPI® Supplies Inc., 400 mesh) was inserted into the gel where the front edge of the desired bands in gel was sharply cut with a surgical knife. By continuing to run the gel for another 10 minutes, Au-nps assemblies were transferred to the grid for inspection.

### Example 3

### Preparation of DNA/DNA or DNA/Peptide Co-Functionalized Au-nps Conjugates

DNA/DNA or DNA/Peptide co-functionalized Au-nps conjugates were prepared according to the method of the present subject matter. To prepare DNA/DNA co-functionalized Au-nps conjugates, two different DNA strands (i.e., thiol-T5: 5′-TTT TT-C3-thiol-3′; and thiol-T30: 5′-TTT TTT TTT TTT TTT TTT TTT TTT TTT TTT-C3-thiol-3′ (SEQ ID NO: 1)) were conjugated on Au-nps to form Co-conjugate 1 (as 1 and 2 of FIG. 6), with different surface densities, using the similar procedure as described in Example 1, except that low-density thiol-T30 was first incubated with Au-nps in a molar ratio of 50 (thiol-T30 to Au-nps) in 0 mM NaCl for 15 minutes, followed by removal of excess reagents using centrifugation (13,200 rpm, 20 minutes). High-density thiol-T5 was then added to the conjugation mixture in a molar ratio of 250 (thiol-T30 to Au-nps) in 0.1 M NaCl, with thiolated oligo(ethylene glycol) introduced after 30 minutes and incubated for another 15 minutes.

Another pair of DNAs, i.e., biotin-thiol-DNA (5′-thiol-C6-GTC TTC TTC TTC TTT CTT TCT CGG AAT TCC GTT GTT TCT TTT CTT T-biotin-3′)(SEQ ID NO: 7 in low surface density and thiol-T30 in high surface density, was also co-conjugated on Au-nps to form Co-conjugate 2 (as 5 and 6 of FIG. 6) using the same procedure as Co-conjugate 1, above.

For the preparation of DNA/peptide co-functionalized Au-nps conjugates, thiol-T5 (5′-TTT TT-C3-thiol-3′) was first incubated with Au-nps in a molar ratio of 50 (thiol-T5 to Au-nps) in 0.1 M NaCl for 30 minutes to form Co-conjugate 3 (as 9 and of FIG. 6), followed by introduction of Peptide 1 (i.e., CALNNAAGFPRGGG{biotin-Lys} (SEQ ID NO: 2)) in a molar ratio of 100 (Peptide 1 to Au-nps). After 30 minutes, thiolated oligo(ethylene glycol) was added and the mixture was incubated for another 30 minutes.

Co-conjugate 4 (as 11 and 12 of FIG. 6), using thiol-T30 and Peptide 2 (i.e., CALNNAALRRASLG (SEQ ID NO: 3)), was similarly synthesized using the same procedure as Co-conjugate 3, above.

As-prepared co-conjugates were incubated with streptavidin coated ferromagnetic particles (Spherotech Inc.), which were pre-washed twice by saline-sodium citrate (SSC) buffer under magnetic field, in saline-sodium citrate (SSC) buffer for more than 2 hours, and then were examined using the gel electrophoresis as described in Example 1, except for 1% agarose gel used herein and running for 60 minutes only. In FIG. 6, samples before binding with the magnetic particles are shown as 1, 3, 5, 9, 11 and 13, while samples after binding with the magnetic particles are shown as 2, 4, 6, 10, 12 and 14.

Through the surface density control over selective strands on Au-nps co-conjugates according to the method of the present subject matter, different co-conjugates become distinguishable in the gel (as 7 to 8 or 15 to 16 of FIG. 6). By comparing the two DNA/DNA co-conjugates (as 3 and 4 in FIG. 6), it is clear that Co-conjugate 2 with high surface density of thiol-T5 (as 8 of FIG. 6) migrates faster in the gel than Co-conjugate 1 with high surface density of thiol-T30 (as 7 of FIG. 6). Similarly, for the two DNA/peptide co-conjugates (as 13 and 14 of FIG. 6), Co-conjugate 3 with thiol-T5 migrates faster (as 16 of FIG. 6) than Co-conjugate 4 with thiol-T30 (as 15 of FIG. 6) in the gel.

### Example 4

### Identification of Multiple Enzymes Using Gel Electrophoresis of DNA and Peptide Co-Functionalized Au-nps Conjugates

For DNA/peptide co-functionalized Au-nps conjugates, Co-conjugate 5 (i.e., thiol-T30 and Peptide 1, above) was prepared using the same procedure as Example 3, described above.

To identify Trypsin (as 4 and 10 of FIG. 7), Co-conjugate 5, was mixed with Trypsin in Buffer 1 (i.e., 50 mM Tris-HCl, pH 8, including 10 mM CaCl₂). For identification of DNase I (as 5 and 11 of FIG. 7), Co-conjugate 5 was mixed with DNase I in Buffer 2 (i.e., 50 mM Tris-HCl, pH 7.5, including 10 mM MgCl₂ and 0.1 mM DTT). For identification of coexistence for DNase I and Trypsin (as 6 and 12 of FIG. 7), Co-conjugate 5 was mixed with both DNase I and Trypsin in Buffer 3 (i.e., 50 mM Tris-HCl, pH 7.5, including 10 mM MgCl₂, 10 mM CaCl₂ and 0.1 mM DTT). A sample of as-prepared co-conjugates, incubated with bovine serum albumin (BSA) in Buffer 1 in parallel, was used as a reference for no enzyme reaction (as 3 and 9 of FIG. 7), while another reference was a sample of as-prepared co-conjugates in water without any buffer or protein (as 2 and 8 of FIG. 7).

After incubation at 37° C. for 12 hours, excessive reagents were removed by repeating centrifugation (13,200 rpm, 20 minutes, twice, interval re-suspending the pellets in equal volume of double distilled water), and the remaining co-conjugates were incubated with streptavidin coated magnetic particles in SSC buffer for more than 2 hours, and then they were examined using gel electrophoresis as described in Example 3. In FIG. 7, samples before binding with the magnetic particles are shown as 2 to 6 of FIG. 7(a), while samples after binding with the magnetic particles are shown as 8 to 12 of FIG. 7(b). Au-nps without any DNA or peptide conjugation but only thiolated oligo(ethylene glycol) coating were used as reference for the basic position of Au-nps in the gel (as 1 and 7 of FIG. 7).

As shown in FIG. 7, it is obvious that when Trypsin exists, band appears after magnetic particle binding, shown as 10 and 12 of FIG. 7. When DNase exists, the mobility of co-conjugates increases significantly, shown as 5, 6 and 12 of FIG. 7. Only when both DNase and Trypsin exist, high mobility band shows up after magnetic particle binding, shown as 12 of FIG. 7.

While the foregoing written description of the present subject matter enables one of ordinary skill to make and use what is considered presently to be the best mode thereof, the person of ordinary skill will understand and appreciate the existence of variations, combinations, and equivalents of the specific embodiment, method, and examples herein. The present subject matter should therefore not be limited by the above described embodiments, methods, and examples, but by all embodiments and methods within the scope and spirit of the invention.

We claim:

1. A method for preparing a nanoparticle having functional molecules attached thereto comprising:
admixing nanoparticles, nucleotides, and functional molecules under suitable conditions to form a conjugate between the nanoparticles and the functional molecules,
wherein the suitable conditions comprise using a buffer, salt, and a stopping agent to cease the conjugation process; and
manipulating the density of the functional molecules to be conjugated to nanoparticles by controlling a salt concentration and the time for introduction of the stopping agent.

2. The method of claim 1 comprising:
incubating a nanoparticle with nucleotides to form a nucleotide-coated nanoparticle,
adjusting the buffer and salt concentration in a conjugation media to stabilize the pH and to reach the salt concentration as the conjugation for certain surface density required,
adding functional molecules into the conjugation media to incubate them with the nucleotide-coated nanoparticles, and
adding a stopping agent in the conjugation media to cease conjugation process of the functional molecules to the nanoparticle.

3. The method of claim 1, wherein low or high loading of functional molecules ranging one to tens of molecules on the nanoparticle is obtained within an hour.

4. The method of claim 1, wherein the stopping agent is thiolated oligo(ethylene glycol).

5. The method of claim 1, wherein the functional molecules are natural or synthetic compounds which are optionally modified in the structures.

6. The method of claim 1, wherein the functional molecules are a single component or a mixture of two or more components.

7. The method of claim 6, wherein the functional molecules are DNA/DNA mixture or DNA/peptide mixture.

8. The method of claim 1, wherein the functional molecules are tiolated molecules.

9. The method of claim 8, wherein the thiolated molecules are thiolated nucleic acids or cystein containing peptides.

10. The method of claim 1, wherein the nucleotides are mononucleotides or oligonucleotides.

11. The method of claim 10, wherein the nucleotides are RNAs or DNAs.

12. The method of claim 1, wherein the nucleotides are ATP or adenosine-rich oligonucleotides.

13. The method of claim 1, wherein the nucleotides are one type of nucleotides or a mixture of two or more types of nucleotides.

14. The method of claim 1, wherein the nanoparticles are metal or semiconductor nanoparticles.

15. The method of claim 14, wherein the nanoparticles are gold nanoparticles, silver nanoparticles, or quantum dots.

16. The method of claim 1, wherein the salt is sodium chloride.

17. The method of claim 8, wherein the thiolated molecules are added either prior to or after adjusting the salt concentration.

18. The method of claim 1, wherein the salt concentration ranges from 0 mM to 1M.

19. The method of claim 18, wherein the salt concentration is determined based on the charges and the surface density of functional molecules to be loaded on the nanoparticle.

20. The method of claim 1, wherein the incubation time prior to adding a stopping agent is from 0 minute to several hours.

21. The method of claim 20, wherein the incubation time is determined based on the size and the surface density of functional molecules to be loaded on the nanoparticle.

22. A method of manipulating the surface density of functional molecules conjugated to nanoparticles, comprising:
incubating nanoparticles with nucleotides to form nucleotide-coated nanoparticles;
adjusting buffer and salt concentration of the conjugation media to stabilize the pH and to reach the salt concentration as the conjugation for certain surface density required;
adding thiolated molecules in the conjugation media to incubate with the nucleotide-coated nanoparticles; and
adding thiolated oligo(ethylene glycol) in the conjugation media to cease the conjugation process of thiolated molecules to nanoparticles.

23. The method of claim 22, wherein the salt concentration is determined based on the charges and the surface density of functional molecules to be loaded on the nanoparticle within the range of 0 mM to 1 M.

24. The method of claim 22, wherein the incubation time is determined based on the size and the surface density of functional molecules to be loaded on the nanoparticle within 0 to several hours.


SEQUENCE LISTING (7 sequences)

SEQ ID NO: 1 - DNA, 30 bp, Artificial Sequence
  Artificial construct generated from bacteriophage M13
tttttttttttttttttttttttttttttt

SEQ ID NO: 2 - protein, 14 aa, Escherichia coli
  MISC_FEATURE (14)..(14): biotin-Lys conjugated to residue 14
CALNNAAGFPRGGG

SEQ ID NO: 3 - protein, 14 aa, Escherichia coli
CALNNAALRRASLG

SEQ ID NO: 4 - DNA, 17 bp, Escherichia coli
  misc_feature (1)..(1): Thiol-C6 conjugated to residue 1
caggaaacagctatgac

SEQ ID NO: 5 - DNA, 16 bp, Escherichia coli
gtaaaacgacggccag

SEQ ID NO: 6 - DNA, 30 bp, Artificial Sequence
  Artificial construct generated from bacteriophage M13
aaaaaaaaaaaaaaaaaaaaaaaaaaaaaa

SEQ ID NO: 7 - DNA, 46 bp, Escherichia coli
  misc_feature (1)..(1): thiol-C6 conjugated to residue 1
gtcttcttcttctttctttctcggaattccgttgtttcttttcttt